(19) United States
(12) Patent Application Publication
(10) Pub. No.: US 2025/0291229 A1
(43) Pub. Date: Sep. 18, 2025

(54) METHOD OF MANUFACTURING WAVEGUIDE DEVICE

(71) Applicant: NGK INSULATORS, LTD., Nagoya-shi (JP)

(72) Inventors: Shun HOSONO, Nagoya-shi (JP); Naotake OKADA, Anjo-shi (JP)

(21) Appl. No.: 19/075,944

(22) Filed: Mar. 11, 2025

(30) Foreign Application Priority Data
Mar. 12, 2024 (JP) 2024-038071

(51) Int. Cl. G02F 1/365; B23K 26/364

(52) U.S. Cl. CPC G02F 1/365; B23K 26/364

(57) ABSTRACT

A method of manufacturing a waveguide device includes: forming, in a first surface of a non-linear optical material substrate, a plurality of groove portions so that one groove portion is spaced apart from another groove portion, and configuring, as a ridge waveguide, at least one of portions of the non-linear optical material substrate that are located between groove portions adjacent to each other; forming, on the first surface of the non-linear optical material substrate, a first low-refractive index layer which has a thickness greater than a depth of the groove portions, so that the ridge waveguide is covered; polishing the first low-refractive index layer from an opposite side from the non-linear optical material substrate to render a surface of the first low-refractive index layer a flat surface; and bonding a first support substrate to the flat surface of the first low-refractive index layer.

### BACKGROUND OF THE INVENTION

This application claims priority under 35 U.S.C. Section 119 to Japanese Patent Application No. 2024-038071 filed on Mar. 12, 2024, the content of which is hereby incorporated by reference into this application.

### 1. Field of the Invention

The present invention relates to a method of manufacturing a waveguide device.

### 2. Description of the Related Art

As one of non-linear optical devices, development of waveguide devices is being advanced. Waveguide devices are expected to be applied to and deployed in a wide range of fields such as next-generation optical communications and quantum-related fields. As an example of those waveguide devices, there has been proposed a wavelength conversion device including: a ferroelectric crystal substrate with a ridge optical waveguide formed thereon; an overclad formed on a first principal surface of the ferroelectric crystal substrate; and an upper substrate adhered to the ferroelectric crystal substrate via the overclad by an upper adhesive layer (for example, see Japanese Patent Application Laid-open No. 2017-227935).

A wavelength conversion device of this sort is manufactured by forming a pair of ridge grooves parallel to each other on the first principal surface of the ferroelectric crystal substrate to use a portion between the ridge grooves as a ridge optical waveguide, then forming a film to serve as an overclad on the first principal surface of the ferroelectric crystal substrate, subsequently applying an adhesive to a top of the overclad, and adhering the upper substrate.

### SUMMARY OF THE INVENTION

However, with the method of manufacturing the wavelength conversion device as described in Japanese Patent Application Laid-open No. 2017-227935, the film to serve as the overclad is formed so as to fall into the ridge grooves of the ferroelectric crystal substrate, with the result that the ridge grooves are filled with an upper adhesive layer on the overclad. This sometimes causes mixing-in of air bubbles between the overclad and the upper adhesive layer. When it is the case, a problem of poor appearance of the wavelength conversion device arises.

In addition, the mixing-in of air bubbles between the overclad and the upper adhesive layer creates portions in which the upper adhesive layer and the overclad are locally not in contact with each other, and may consequently cause adhesion between those layers to drop. In addition, the presence of air bubbles renders the upper adhesive layer uneven, and the unevenness causes application of stress to an internal structure of the wavelength conversion device in some cases. The wavelength conversion device may end up having insufficient strength as a result.

A primary object of the present invention is to provide a method of manufacturing a waveguide device with which a waveguide device having excellent appearance and strength can be manufactured.
[1] A method of manufacturing a waveguide device according to one embodiment of the present invention includes: preparing a non-linear optical material substrate; forming, in a first surface of the non-linear optical material substrate which is located on one side of a thickness direction, a plurality of groove portions extending in a direction intersecting with the thickness direction so that one groove portion is spaced apart from another groove portion, and configuring, as a ridge waveguide, at least one of portions of the non-linear optical material substrate that are located between groove portions adjacent to each other out of the plurality of groove portions; forming, on the first surface of the non-linear optical material substrate, a first low-refractive index layer which is lower in refractive index than the non-linear optical material substrate and which has a thickness greater than a depth of the plurality of groove portions, so that the ridge waveguide is covered; polishing the first low-refractive index layer from an opposite side from the non-linear optical material substrate to render a surface of the first low-refractive index layer that is on the opposite side from the non-linear optical material substrate a substantially flat surface; and bonding, to the substantially flat surface of the first low-refractive index layer, a first support substrate via a first bonding layer.
[2] In the method of manufacturing a waveguide device according to the above-mentioned item [1], the preparing of the non-linear optical material substrate may include: forming, on a second surface of the non-linear optical material substrate which is on an opposite side from the first surface, a second low-refractive index layer which is lower in refractive index than the non-linear optical material substrate; bonding, to a surface of the second low-refractive index layer that is on an opposite side from the non-linear optical material substrate, a second support substrate via a second bonding layer; and polishing the non-linear optical material substrate from an opposite side from the second low-refractive index layer.
[3] In the method of manufacturing a waveguide device according to the above-mentioned item [2], the preparing of the non-linear optical material substrate may further include, prior to the forming of the second low-refractive index layer, forming a periodically poled portion on the second surface of the non-linear optical material substrate.
[4] In the method of manufacturing a waveguide device according to any one of the above-mentioned items [1] to [3], the first bonding layer may be formed of a resin material.
[5] In the method of manufacturing a waveguide device according to the above-mentioned item [2] or [3], the second bonding layer may be formed of a resin material.
[6] In the method of manufacturing a waveguide device according to any one of the above-mentioned items [1] to [5], the polishing of the first low-refractive index layer may include polishing the first low-refractive index layer until a measurement between the substantially flat surface of the first low-refractive index layer and the ridge waveguide in the thickness direction reaches 1.0 or less relative to the depth of the plurality of groove portions.
[7] In the method of manufacturing a waveguide device according to any one of the above-mentioned items [1] to [6], the depth of the plurality of groove portions may be 1.5 μm or more and 3.0 μm or less.
[8] In the method of manufacturing a waveguide device according to any one of the above-mentioned items [1] to [7], the non-linear optical material substrate may be formed of lithium niobate, and/or lithium tantalate, that contains magnesium oxide as a dopant.
[9] In the method of manufacturing a waveguide device according to any one of the above-mentioned items [1] to [8], the first low-refractive index layer may contain silicon dioxide.

### BRIEF DESCRIPTION OF THE DRAWINGS

FIG. 1 is a schematic explanatory diagram for illustrating a preparation step included in a method of manufacturing a waveguide device according to an embodiment of the present invention.

FIG. 2 is a schematic explanatory diagram for illustrating a processing step, which follows the preparation step of FIG. 1.

FIG. 3 is a schematic explanatory diagram for illustrating a first low-refractive index layer forming step, which follows the processing step of FIG. 2.

FIG. 4 is a schematic explanatory diagram for illustrating a first polishing step, which follows the first low-refractive index layer forming step of FIG. 3.

FIG. 5 is a schematic explanatory diagram for illustrating a first bonding step, which follows the first polishing step of FIG. 4.

FIG. 6 is a schematic explanatory diagram for illustrating a second low-refractive index layer forming step included in the preparation step of FIG. 1.

FIG. 7 is a schematic explanatory diagram for illustrating a second bonding step, which follows the second low-refractive index layer forming step of FIG. 6.

FIG. 8 is a schematic perspective view taken along the line VIII-VIII′ in the waveguide device of FIG. 5.

FIG. 9 is a schematic configuration diagram of a periodically poled portion included in the waveguide device of FIG. 8.

### DESCRIPTION OF THE EMBODIMENTS

Embodiments of the present invention are described below. However, the present invention is not limited to these embodiments. In addition, in the drawings, the width, thickness, shape, and the like of each portion may be schematically illustrated as compared to those in the embodiments in order to provide a clearer description, but the drawings are merely examples and do not limit the interpretation of the present invention.

### A. Outline of a Method of Manufacturing a Waveguide Device

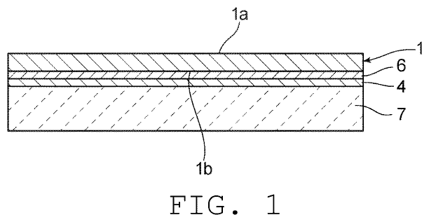

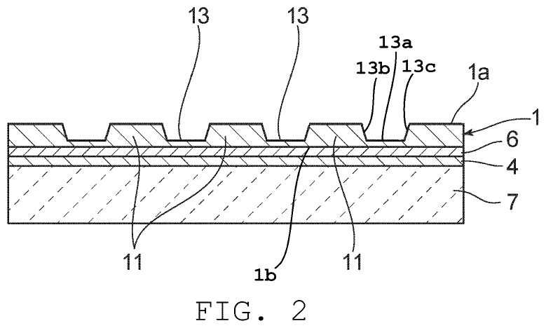

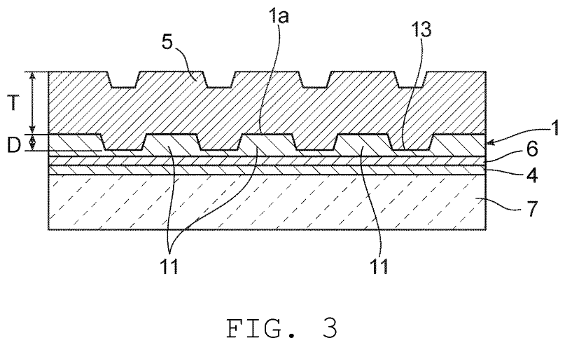

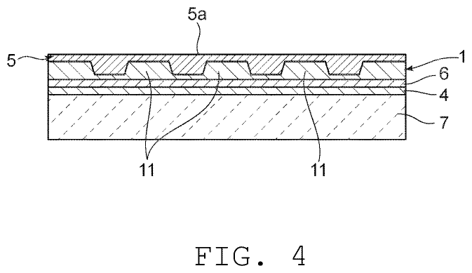

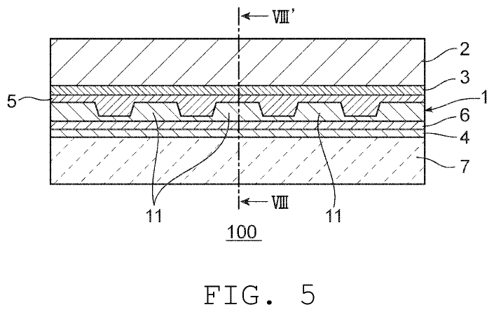

FIG. 1 is a schematic explanatory diagram for illustrating a preparation step included in a method of manufacturing a waveguide device according to an embodiment of the present invention. FIG. 2 is a schematic explanatory diagram for illustrating a processing step, which follows the preparation step of FIG. 1. FIG. 3 is a schematic explanatory diagram for illustrating a first low-refractive index layer forming step, which follows the processing step of FIG. 2. FIG. 4 is a schematic explanatory diagram for illustrating a first polishing step, which follows the first low-refractive index layer forming step of FIG. 3. FIG. 5 is a schematic explanatory diagram for illustrating a first bonding step, which follows the first polishing step of FIG. 4.

The method of manufacturing a waveguide device according to one embodiment of the present invention includes the preparation step, the processing step, the first low-refractive index layer forming step, the first polishing step, and the first bonding step in the stated order.

In the preparation step, a non-linear optical material substrate 1 having a predetermined thickness is prepared. The non-linear optical material substrate 1 includes a first surface 1a positioned on one side of a thickness direction, and a second surface 1b on an opposite side from the first surface 1a.

In the processing step, a plurality of groove portions 13 are formed on the first surface 1a of the non-linear optical material substrate 1. Each of the plurality of groove portions 13 extends in a direction intersecting with the thickness direction of the non-linear optical material substrate 1.

As illustrated in FIG. 2, in the one embodiment, Each of the groove portions 13 includes a bottom surface 13a, a first side surface 13b, and a second side surface 13c. The bottom surface 13a is positioned between the first surface 1a and the second surface 1b of the non-linear optical material substrate 1 in the thickness direction of the non-linear optical material substrate 1. A width direction of the bottom surface 13a typically intersects with the thickness direction of the non-linear optical material substrate 1 and with the direction in which the groove portions 13 extend. The first side surface 13b connects one end of the bottom surface 13a in the width direction and the first surface 1a. The second side surface 13c connects another end of the bottom surface 13a in the width direction and the first surface 1a.

In another embodiment, at least one of the groove portions 13 may be designed so as to have the bottom surface 13a and only one of the first side surface 13b and the second side surface 13c. In other words, at least one of the groove portions 13 may have a notched shape that is open on one side of the width direction.

The plurality of groove portions 13 are formed so as to be spaced apart from one another. At least one of portions of the non-linear optical material substrate 1 that are located between the groove portions 13 adjacent to each other out of the plurality of groove portions 13 is configured as a ridge waveguide 11.

As illustrated in FIG. 3, in the first low-refractive index layer forming step, a first low-refractive index layer 5 is formed on the first surface 1a of the non-linear optical material substrate 1 so as to cover the ridge waveguide 11. The first low-refractive index layer 5 is lower in refractive index than the non-linear optical material substrate 1. A thickness T of the first low-refractive index layer 5 exceeds a depth D of the groove portions 13. Herein, the “depth of the groove portions” means a measurement between the first surface 1a of the non-linear optical material substrate 1 and the bottom surface 13a of each of the groove portions 13 in the thickness direction of the non-linear optical material substrate 1.

In the polishing step, the first low-refractive index layer 5 is polished from an opposite side from the non-linear optical material substrate 1. This renders a surface of the first low-refractive index layer 5 that is on the opposite side from the non-linear optical material substrate 1 a flat surface 5a as illustrated in FIG. 4. In the first bonding step, a first support substrate 2 is bonded to the flat surface 5a of the first low-refractive index layer 5 via a first bonding layer 3.

According to this method, after the ridge waveguide 11 is provided by forming the plurality of groove portions 13 in the non-linear optical material substrate 1, the first low-refractive index layer 5 having the thickness T which exceeds the depth D of the groove portions 13 is formed, and then the surface of the first low-refractive index layer 5 that is on the opposite side from the non-linear optical material substrate 1 is rendered the flat surface 5a by polishing. Mixing-in of air bubbles between the first low-refractive index layer 5 and the first bonding layer 3 is accordingly avoidable when the first support substrate 2 is bonded to the flat surface 5a of the first low-refractive index layer 5 via the first bonding layer 3. This enables smooth manufacture of a waveguide device 100 having excellent appearance and strength.

As illustrated in FIG. 1, in the preparation step, the non-linear optical material substrate 1 having the predetermined thickness is prepared by any suitable means. The thickness of the non-linear optical material substrate 1 prepared in the preparation step is, for example, from 0.1 μm to 10 μm, is preferred to be from 0.15 μm to 7.0 μm, and is more preferred to be from 3.0 μm to 5.0 μm.

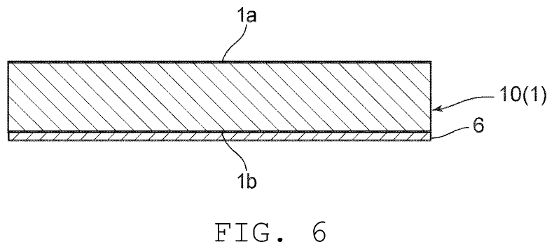

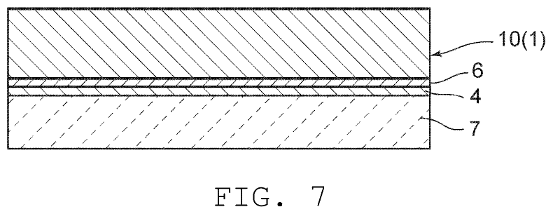

As illustrated in FIGS. 6 and 7, in one embodiment, the preparation step includes a second low-refractive index layer forming step, a second bonding step, and a second polishing step. A multi-layer body including the non-linear optical material substrate 1 having the predetermined thickness is thus prepared.

In the second low-refractive index layer forming step, a second low-refractive index layer 6 is formed on the second surface 1b of the non-linear optical material substrate 1. The second low-refractive index layer 6 is lower in refractive index than the non-linear optical material substrate 1. A thickness of the non-linear optical material substrate 1 that is subjected to the second low-refractive index layer forming step is typically greater than a thickness of the non-linear optical material substrate 1 that is ultimately prepared in the preparation step. The non-linear optical material substrate 1 that is subjected to the second low-refractive index layer forming step is hereinafter referred to as “thick substrate 10” for distinction.

The second surface 1b of the thick substrate 10 (non-linear optical material substrate 1) is substantially flat. Consequently, in the second low-refractive index layer 6 formed on the second surface 1b, a surface on an opposite side from the thick substrate 10 can be substantially flat.

In the second bonding step, a second support substrate 7 is bonded to a surface of the second low-refractive index layer 6 that is on an opposite side from the thick substrate 10 via a second bonding layer 4. In the second polishing step, the thick substrate 10 is polished from an opposite side from the second low-refractive index layer 6.

According to this method, the surface of the second low-refractive index layer 6 that is on the opposite side from the thick substrate 10 is substantially flat and, with the second support substrate 7 bonded to the substantially flat surface, mixing-in of air bubbles between the second low-refractive index layer 6 and the second bonding layer 4 is avoidable. In addition, the thick substrate 10 can be thinned with precision because polishing of the thick substrate 10 is performed with the thick substrate 10 supported by the second support substrate 7 via the second low-refractive index layer 6 and the second bonding layer 4, and the non-linear optical material substrate 1 of a desired thickness described above can accordingly be prepared in a stable manner. Further, with the first support substrate 2 positioned on one side of the thickness direction and the second support substrate 7 positioned on another side of the thickness direction in the manufactured waveguide device 100, the waveguide device 100 can be improved in ease of handling (see FIG. 5).

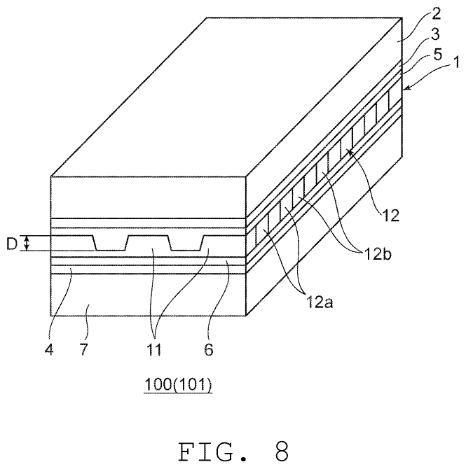

As illustrated in FIG. 6, in one embodiment, the preparation step further includes a periodic poling creation step before the second low-refractive index layer forming step. In the periodic poling creation step, a periodically poled portion 12 is formed on the second surface 1b of the thick substrate 10 (see FIG. 8). The waveguide device 100 including the periodically poled portion 12, that is, a wavelength conversion device 101, can thus be manufactured (see FIG. 8).

Herein, “waveguide device” encompasses both of a wafer (waveguide device wafer) on which at least one waveguide device is formed and chips obtained by cutting the waveguide device wafer into pieces.

### B. Details of the Method of Manufacturing a Waveguide Device

Next, details of the method of manufacturing a waveguide device are described with reference to FIG. 1 to FIG. 7.

### B-1. Preparation Step

### B-1-1. Thick Substrate

As illustrated in FIG. 6, the thick substrate 10 is the same as the non-linear optical material substrate 1 ultimately prepared in the preparation step, except for the thickness. The thick substrate 10 has any suitable thickness. The thickness of the thick substrate 10 is, for example, from 200 μm to 1,000 μm, and is preferred to be from 250 μm to 350 μm.

Each of the first surface 1a and the second surface 1b in the thick substrate 10 is typically a flat surface extending along a direction orthogonal to a thickness direction of the thick substrate 10.

There are no particular limitations on what shape the thick substrate 10 has when viewed from the thickness direction. Examples of the shape of the thick substrate 10 viewed from the thickness direction include a circular shape, an elliptical shape, and a polygonal shape. A maximum measurement in a planar direction orthogonal to the thickness direction of the thick substrate 10 is, for example, from 10 mm to 200 mm, and is preferred to be from 100 mm to 200 mm.

The thick substrate 10 is formed of any suitable non-linear optical material, and is preferred to be formed of a single crystal of a non-linear optical material.

Examples of the non-linear optical material include lithium niobate (LiNbO₃: LN), lithium tantalate (LiTaO₃: LT), potassium titanyl phosphate (KTiOPO₄: KTP), potassium-lithium niobate (KₓLi₍₁₋ₓ₎NbO₂: KLN), potassium niobate (KNbO₃: KN), potassium tantalate-niobate (KNbₓTa₍₁₋ₓ₎O₃: KTN), and a solid solution of lithium niobate and lithium tantalate. The non-linear optical materials may be used alone or in combination thereof.

The non-linear optical material may contain a dopant. Examples of the dopant include magnesium oxide and zinc oxide. The dopants may be used alone or in combination thereof.

Of those non-linear optical materials, lithium niobate (LN), and/or lithium tantalate (LT), that contains magnesium oxide as a dopant is preferred.

Those non-linear optical materials have a relatively large non-linear optical constant d33, and optical damage in the waveguide device 100 can accordingly be avoided in a stable manner. The non-linear optical constant d33 is typically 15 pm/V or more.

The thick substrate 10 may be an X-cut substrate or a Y-cut substrate. The thick substrate 10 is preferred to be a Y-cut substrate, and more preferred to be a Y-cut substrate having an off-cut of 5°.

A refractive index of the thick substrate 10 at 473 Hz is, for example, from 2.15 to 2.32, and is preferred to be from 2.19 to 2.21.

### B-1-2. Periodic Poling Creation Step

In one embodiment, the thick substrate 10 is first subjected to the periodic poling creation step. In the periodic poling creation step, the periodically poled portion 12 is formed on the second surface 1b of the thick substrate 10.

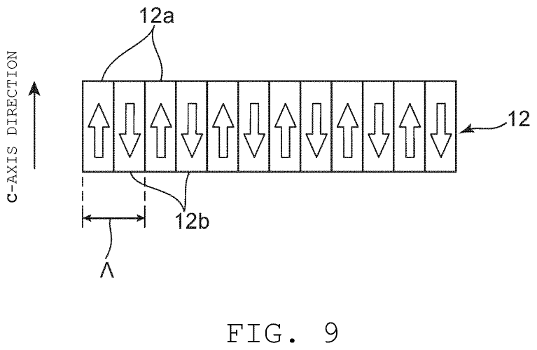

To describe in more detail, an electrode pattern is formed in a comb-tooth shape on the second surface 1b of the thick substrate 10. A period in which a comb tooth appears corresponds to a poling period A in the periodically poled portion 12 (see FIG. 9). Next, a voltage is applied to the thick substrate 10 in a c-axis direction via the electrode pattern (see FIG. 9). The periodically poled portion 12 is formed in this manner. The electrode pattern is then removed by etching.

As illustrated in FIG. 9, the periodically poled portion 12 has any suitable configuration that can express quasi-phase matching (QPM). The periodically poled portion 12 has a first polarized portion 12a and a second polarized portion 12b (inversely polarized domains) alternately in a first planar direction orthogonal to the thickness direction of the thick substrate 10.

The first polarized portion 12a is polarized in the c-axis direction. The second polarized portion 12b is polarized in a direction opposite from the direction in which the first polarized portion 12a is polarized. In the illustrated example, the first polarized portion 12a is polarized in a second planar direction orthogonal to both of the thickness direction and the first planar direction of the thick substrate 10. A domain width of each of the first polarized portion 12a and the second polarized portion 12b is adjusted in any suitable manner.

The poling period Λ in the periodically poled portion 12 is, for example, from 1 μm to 50 μm, and is preferred to be from 3 μm to 30 μm. A poling ratio (inversely polarized domain width/poling period) is, for example, from 0.1 to 0.9, and is preferred to be from 0.3 to 0.7.

In the periodic poling creation step, more than one periodically poled portion 12 described above may be formed. The number of periodically poled portions 12 is not particularly limited. For example, the number of periodically poled portions 12 is from 1 to 200,000.

In a case of forming a plurality of periodically poled portions 12 on the second surface 1b, the plurality of periodically poled portions 12 are typically arranged in parallel to one another in the second planar direction of the thick substrate 10 so as to be spaced apart from one another.

### B-1-3. Second Low-Refractive Index Layer Forming Step

Next, as illustrated in FIG. 6, the second low-refractive index layer 6 is formed on the second surface 1b of the thick substrate 10.

To describe in more detail, a material of the second low-refractive index layer 6 is deposited on the second surface 1b of the thick substrate 10 by any suitable deposition method.

Examples of the deposition method include sputtering, vacuum deposition, ion plating, chemical vapor deposition (CVD), and atomic layer deposition (ALD). Of the deposition methods, sputtering is preferred.

A material of the second low-refractive index layer 6 is any suitable low-refractive index material. The low-refractive index material is lower in refractive index than the non-linear optical material described above. Examples of the low-refractive index material include silicon dioxide (SiO₂), aluminum oxide (Al₂O₃), tantalum oxide (Ta₂O₅), and silicon nitride (Si₃N₄). The low-refractive index materials may be used alone or in combination thereof.

Of the low-refractive index materials, silicon dioxide (SiO₂) is preferred. When containing silicon dioxide, the second low-refractive index layer 6 can have a satisfactorily low refractive index, and can accordingly have excellent thermal stability.

In the illustrated example, the second low-refractive index layer 6 is formed on the entirety of the second surface 1b of the thick substrate 10.

A surface of the second low-refractive index layer 6 that is on an opposite side from the thick substrate 10 is typically a flat surface extending along a direction orthogonal to the thickness direction of the thick substrate 10. Flatness of the surface of the second low-refractive index layer 6 that is on the opposite side from the thick substrate 10 is, for example, from 0.0001 μm to 0.1 μm, and is preferred to be from 0.0001 μm to 0.01 μm. The flatness is measured in conformity to, for example, JIS B 0621.

A thickness of the second low-refractive index layer 6 is, for example, from 0.01 μm to 10 μm, and is preferred to be from 0.1 μm to 1.0 μm.

A refractive index of the second low-refractive index layer 6 at 473 Hz is, for example, from 1.40 to 1.60, and is preferred to be from 1.45 to 1.49.

### B-1-4. Second Bonding Step Next, as illustrated in FIG. 7, the second support substrate 7 is bonded to the second low-refractive index layer 6 via the second bonding layer 4.

The second bonding layer 4 may be formed of an inorganic material, or an organic material.

Examples of the inorganic material for forming the second bonding layer 4 include silicon dioxide, amorphous silicon, and tantalum oxide. When formed of an inorganic material, the second bonding layer 4 may be formed by directly bonding the second low-refractive index layer 6 and the second support substrate 7.

Examples of the organic material for forming the second bonding layer 4 include: curable resins such as an ultraviolet (UV)-curable resin and a thermosetting resin; and thermoplastic resins. Of those, a curable resin is preferred, and a UV-curable resin is more preferred. Specific examples of the curable resin include a phenol resin and an epoxy resin.

In one embodiment, the second bonding layer 4 is formed of an organic material. When formed of an organic material, the second bonding layer 4 is capable of mitigating stress caused by a difference in thermal expansion coefficient between the second low-refractive index layer 6 and the second support substrate 7 at a change in temperature of the waveguide device 100. As a result, characteristics of the waveguide device 100 can be maintained at a satisfactory level despite the change in temperature.

When the organic material for forming the second bonding layer 4 is a curable resin, a curable adhesive containing a monomer component suitable for the curable resin is applied to the surface of the second low-refractive index layer 6 that is on the opposite side from the thick substrate 10 by any suitable application method (typically spin coating).

A coat that is a film by application is thus formed by application from the curable adhesive on the surface of the second low-refractive index layer 6. In the illustrated example, the coat is formed on the entirety of the surface of the second low-refractive index layer 6 that is on the opposite side from the thick substrate 10.

The coat is then heated and/or irradiated with UV light, with the second support substrate 7 kept in contact with the coat, to thereby cure the curable adhesive. The second bonding layer 4 formed of the curable resin is thus formed to bond the second low-refractive index layer 6 and the second support substrate 7 together.

A thickness of the second bonding layer 4 is, for example, from 0.001 μm to 10 μm, and is preferred to be from 0.3 μm to 3.0 μm.

The second support substrate 7 is formed of any suitable inorganic material. Examples of the inorganic material for forming the second support substrate 7 include lithium niobate (LiNbO₃: LN), lithium tantalate (LiTaO₃: LT), silicon (Si), glass, SiAlON (Si₃N₄—Al₂O₃), mullite (3Al₂O₃·2SiO₂, 2Al₂O₃·SiO₂), aluminum nitride (AlN), silicon nitride (Si₃N₄), magnesium oxide (MgO), sapphire, quartz, crystal, gallium nitride (GaN), silicon carbide (SiC), and gallium oxide (Ga₂O₃). The inorganic materials may be used alone or in combination thereof. Of the inorganic materials for forming the second support substrate 7, LN is preferred.

The second support substrate 7 has any suitable thickness. The thickness of the second support substrate 7 is, for example, from 300 μm to 1,000 μm.

### B-1-5. Second Polishing Step

Next, the thick substrate 10 is polished from an opposite side from the second low-refractive index layer 6 by any suitable polishing method to be thinned. More specifically, the thick substrate 10 that has a thickness of 200 μm or more is thinned so as to become the non-linear optical material substrate 1 having a thickness of 10 μm or less (see FIG. 1).

An example of the polishing method is a chemical mechanical polishing process (CMP polishing).

As illustrated in FIG. 1, the non-linear optical material substrate 1 having a thickness of 10 μm or less is thus prepared. In the illustrated example, a multi-layer body including the non-linear optical material substrate 1 that is 10 μm or less in thickness, the second low-refractive index layer 6, the second bonding layer 4, and the second support substrate 7 in the stated order is prepared.

### B-2. Processing Step

As illustrated in FIG. 2, in the processing step, the plurality of groove portions 13 are formed on the first surface la of the non-linear optical material substrate 1 by any suitable processing method.

Examples of the processing method include laser processing and reactive ion etching (RIE), and laser processing is preferred.

In one embodiment, the plurality of groove portions 13 each extend in the first planar direction orthogonal to the thickness direction of the non-linear optical material substrate 1. The groove portions 13 each have any suitable shape in section when cut in a direction orthogonal to the direction in which the groove portions 13 extend. A sectional shape of each of the groove portions 13 is typically a schematically letter U shape open on the first surface 1a side, or a schematically letter L-shape open on the first surface 1a side and on one side of the width direction.

The groove portions 13 that have a schematically letter U shape in section each have the bottom surface 13a, the first side surface 13b, and the second side surface 13c. The groove portions 13 that have a schematically letter L shape in section each have the bottom surface 13a and the first side surface 13b, or the bottom surface 13a and the second side surface 13c.

In one embodiment, the bottom surface 13a is substantially parallel to the first surface 1a of the non-linear optical material substrate 1. Each of the first side surface 13b and the second side surface 13c may be substantially parallel to the thickness direction of the non-linear optical material substrate 1, or may intersect with the thickness direction of the non-linear optical material substrate 1. In the illustrated example, each of the first side surface 13b and the second side surface 13c intersect with the thickness direction of the non-linear optical material substrate 1.

A measurement (depth D) of the groove portions 13 in the thickness direction of the non-linear optical material substrate 1 is, when the thickness of the non-linear optical material substrate 1 is given as 100%, from 30% to 100%, for example, and is preferred to be from 40% to 60%.

The depth D of the groove portions 13 is, for example, from 0.5 μm to 5.0 μm, and is preferred to be from 1.5 μm to 3.0 μm. When the depth D of the groove portions 13 is within this range, the ridge waveguide 11 having a satisfactory height can be formed.

The plurality of groove portions 13 are arranged in parallel in the second planar direction orthogonal to the first planar direction of the non-linear optical material substrate 1 so as to be spaced apart from one another. The plurality of groove portions 13 are substantially parallel to one another.

The plurality of groove portions 13 may be designed so that all have a schematically letter U shape in section, or may be designed so that some have a schematically letter L shape in section, with the rest having a schematically letter U shape in section. The groove portions 13 that have a schematically letter L shape in section out of the plurality of groove portions 13 are typically positioned in end portions in the second planar direction.

The number of the plurality of groove portions 13 is not particularly limited. For example, the number of the plurality of groove portions 13 is from 2 to 54.

A portion of the non-linear optical material substrate 1 that is located between the groove portions 13 adjacent to each other out of the plurality of groove portions 13 is configured as the ridge waveguide 11. Accordingly, the number of portions each formed as the ridge waveguide 11 in the processing step is typically the number of the plurality of groove portions 13 minus 1.

The ridge waveguide 11 extends in the same direction as the direction in which the groove portions 13 extend. One end surface in the direction in which the ridge waveguide 11 extends is configured as an input end surface from which an optical wave enters (see FIG. 8). Another end surface in the direction in which the ridge waveguide 11 extends is configured as an output end surface from which the optical wave exits (see FIG. 8).

The ridge waveguide 11 has any suitable shape in section when cut in a direction orthogonal to the direction in which the ridge waveguide 11 extends. The sectional shape of the ridge waveguide 11 is, for example, a quadrangular shape such as a square, a rectangle, a trapezoid, or a parallelogram. In the illustrated example, the sectional shape of the ridge waveguide 11 is a trapezoidal shape that grows narrower as a distance from the second surface 1b increases.

Typically, a measurement (height) of the ridge waveguide 11 in the thickness direction of the non-linear optical material substrate 1 is substantially the same as the depth D of the groove portions 13 described above. A width of the ridge waveguide 11 is substantially the same as an interval between the groove portions 13 adjacent to each other, and is, for example, from 1 μm to 10 μm.

In a case in which the method of manufacturing a waveguide device includes the periodic poling creation step described above, the plurality of groove portions 13 are formed in the processing step so that at least one ridge waveguide 11 includes the periodically poled portion 12 (see FIG. 8).

### B-3. First Low-Refractive Index Layer Forming Step

Next, as illustrated in FIG. 3, the first low-refractive index layer 5 is formed on the first surface 1a of the non-linear optical material substrate 1 in which the plurality of groove portions 13 have been formed.

To describe in more detail, a material of the first low-refractive index layer 5 is deposited on the first surface 1a of the non-linear optical material substrate 1 by any suitable deposition method.

Examples of the deposition method in the first low-refractive index layer forming step include sputtering, vacuum evaporation, ion plating, chemical vapor deposition (CVD), and atomic layer deposition (ALD), and sputtering is preferred.

A material of the first low-refractive index layer 5 is, for example, the same low-refractive index material as the material of the second low-refractive index layer 6 described above, and silicon dioxide (SiO₂) is preferred. When containing silicon dioxide, the first low-refractive index layer 5 can have a satisfactorily low refractive index, and can accordingly have excellent thermal stability.

In the illustrated example, the first low-refractive index layer 5 is formed on the entirety of the first surface 1a of the non-linear optical material substrate 1. The first low-refractive index layer 5 is formed so as to extend along the groove portions 13 and the ridge waveguide 11 that are formed in the non-linear optical material substrate 1. Accordingly, the groove portions 13 are each filled with the first low-refractive index layer 5. Concavities and convexities corresponding to the groove portions 13 and the ridge waveguide 11 are thus formed in the surface of the first low-refractive index layer 5 that is on the opposite side from the non-linear optical material substrate 1.

The thickness T of the first low-refractive index layer 5 prior to the first polishing step is greater than the depth D of the groove portions 13. The thickness T prior to the first polishing step is, for example, more than a value that is the depth D of the groove portions 13 times one, and is preferred to be twice larger than the depth D or more. When a proportion of the thickness T of the first low-refractive index layer 5 to the depth D of the groove portions 13 is equal to or more than this lower limit, exposure of the ridge waveguide 11 from the first low-refractive index layer 5 is avoidable even when the polishing in the first polishing step is continued until the surface of the first low-refractive index layer 5 that is on the opposite side from the non-linear optical material substrate 1 is substantially flat.

As an upper limit, the thickness T of the first low-refractive index layer 5 prior to the first polishing step is, for example, the depth D of the groove portions 13 times ten or less, or, in another example, the depth D of the groove portions 13 times two or less.

The thickness T of the first low-refractive index layer 5 prior to the first polishing step is from 1.5 μm to 6.0 μm, for example.

A refractive index of the first low-refractive index layer 5 at 473 Hz is, for example, from 1.40 to 1.60, and is preferred to be from 1.45 to 1.49.

### B-4. First Polishing Step

Next, as illustrated in FIG. 4, the first low-refractive index layer 5 is polished from the opposite side from the non-linear optical material substrate 1. More specifically, the first low-refractive index layer 5 is polished by any suitable polishing method so that the concavities and convexities are removed from the surface of the first low-refractive index layer 5 that is on the opposite side from the non-linear optical material substrate 1.

An example of the polishing method is a chemical mechanical polishing process (CMP polishing). A polishing quantity in the first polishing step is typically equal to or more than the depth D of the groove portions 13.

This renders the surface of the first low-refractive index layer 5 that is on the opposite side from the non-linear optical material substrate 1 the flat surface 5a. The flat surface 5a of the first low-refractive index layer 5 typically extends along the direction orthogonal to the thickness direction of the non-linear optical material substrate 1.

The flatness of the flat surface 5a of the first low-refractive index layer 5 is, for example, from 0.0001 μm to 0.1 μm, and is preferred to be from 0.0001 μm to 0.01 μm.

A measurement between the flat surface 5a of the first low-refractive index layer 5 and the ridge waveguide 11 is, for example, 1.0 or less relative to the depth D of the groove portions 13, is preferred to be 0.7 or less, and is more preferred to be 0.5 or less. As a lower limit, the measurement between the flat surface 5a of the first low-refractive index layer 5 and the ridge waveguide 11 is, for example, 0.1 or more relative to the depth D of the groove portions 13, and is 0.2 or more in another example.

When the measurement between the flat surface 5a and the ridge waveguide 11 relative to the depth D of the groove portions 13 is within this range, the first low-refractive index layer 5 can cover the ridge waveguide 11 in a stable manner, and the waveguide device 100 can be thinned as well.

The measurement between the flat surface 5a of the first low-refractive index layer 5 and the ridge waveguide 11 is, for example, from 0.1 μm to 3.0 μm, and is preferred to be from 0.5 μm to 1.5 μm.

### B-5. First Bonding Step

Next, as illustrated in FIG. 5, the first support substrate 2 is bonded to the first low-refractive index layer 5 via the first bonding layer 3.

The first bonding layer 3 may be formed of an inorganic material, or an organic material.

Examples of the inorganic material for forming the first bonding layer 3 include the same inorganic materials mentioned above as usable for the second bonding layer 4.

Examples of the organic material for forming the first bonding layer 3 include the same organic materials mentioned above as usable for the second bonding layer 4.

In one embodiment, the first bonding layer 3 is formed of an organic material. When formed of an organic material, the first bonding layer 3 is capable of mitigating stress caused by a difference in thermal expansion coefficient between the first low-refractive index layer 5 and the first support substrate 2 at a change in temperature of the waveguide device 100. As a result, characteristics of the waveguide device 100 can be maintained at a satisfactory level despite the change in temperature.

When the organic material for forming the first bonding layer 3 is a curable resin, a curable adhesive containing a monomer component suitable for the curable resin is applied to the flat surface 5a of the first low-refractive index layer 5 by any suitable application method (typically spin coating).

A coat that is a film by application is thus formed by application from the curable adhesive on the flat surface 5a of the first low-refractive index layer 5. In the illustrated example, the coat is formed on the entirety of the flat surface 5a of the first low-refractive index layer 5.

The coat is then heated and/or irradiated with UV light, with the first support substrate 2 kept in contact with the coat, to thereby cure the curable adhesive. The first bonding layer 3 formed of the curable resin is thus formed to bond the first low-refractive index layer 5 and the first support substrate 2 together.

A thickness of the first bonding layer 3 is, for example, from 0.001 μm to 10 μm, and is preferred to be from 0.3 μm to 3.0 μm.

The first support substrate 2 is formed of any suitable inorganic material. Examples of the inorganic material for forming the first support substrate 2 include the same inorganic materials mentioned above as usable for the second support substrate 7. Of the examples of the inorganic material for forming the first support substrate 2, LN is preferred.

The first support substrate 2 has any suitable thickness. A thickness range of the first support substrate 2 is the same as the thickness range of the second support substrate 7 described above.

The waveguide device 100 is manufactured in the manner described above. A thickness of the waveguide device 100 is, for example, from 300 μm to 2,000 μm, and is preferred to be from 500 μm to 1,000 μm.

In one embodiment, the waveguide device 100 includes the first support substrate 2, the first bonding layer 3, the first low-refractive index layer 5, the non-linear optical material substrate 1, the second low-refractive index layer 6, the second bonding layer 4, and the second support substrate 7 in the stated order.

The non-linear optical material substrate 1 is provided with the ridge waveguide 11 as described above. The ridge waveguide 11 is surrounded by the first low-refractive index layer 5 and the second low-refractive index layer 6. Accordingly, the ridge waveguide 11 functions as a core, and the first low-refractive index layer 5 and the second low-refractive index layer 6 function as clads.

Typically, an optical wave having a wavelength of from 0.5 μm to 1.6 μm is incident on the ridge waveguide 11. In this case, the first low-refractive index layer 5 and the second low-refractive index layer 6 can suppress leakage of the optical wave from the ridge waveguide 11. This enables the ridge waveguide 11 to transfer the optical wave at a low loss.

As illustrated in FIG. 8, in a case in which the ridge waveguide 11 includes the periodically poled portion 12, the waveguide device 100 may function as the wavelength conversion device 101. The wavelength conversion device 101 is capable of converting the wavelength of the optical wave traveling through the ridge waveguide 11, by quasi-phase matching (QPM) of the periodically poled portion 12.

The wavelength conversion is, for example, parametric down-conversion (PDC), optical parametric amplification (OPA), second-harmonic generation (SHG), or sum frequency generation (SFG).

### EXAMPLES

The present invention is specifically described below by way of Examples, but the present invention is not limited by these Examples.

### Example 1

### (1) Preparation Step

A lithium niobate substrate doped with magnesium oxide (MgO:LN substrate) was prepared as a non-linear optical material substrate (thick substrate). The MgO:LN substrate included an orientation flat portion (OF portion), and an orientation of 5° Y-Z was used. The MgO:LN substrate was 4 inches in diameter and 300 μm in thickness.

An electrode pattern having a comb-tooth shape was formed on one surface (a second surface) in a thickness direction of the MgO:LN substrate, and a voltage was applied in a c-axis direction.

A periodically poled portion was thus formed on the MgO:LN substrate. In the periodically poled portion, a first polarized portion and a second polarized portion which were polarized in directions opposite from each other were aligned alternately in a first planar direction orthogonal to a thickness direction of the MgO:LN substrate. Three periodically poled portions were arranged in parallel to one another in a second planar direction orthogonal to the first planar direction so as to be spaced apart from one another. After poling, the comb-tooth shaped electrode was removed by etching.

Next, on a periodic poling creation surface of the MgO:LN substrate, SiO₂ was deposited by sputtering to form a SiO₂ film (0.4 μm-thick) as a second low-refractive index layer.

Next, a curable adhesive was evenly applied by spin coating to a surface of the SiO₂ film that was on an opposite side from the MgO:LN substrate, to thereby form a coat having a thickness of 0.4 μm. Then the curable adhesive was cured with a lithium niobate (LN) substrate (500 μm-thick) as a second support substrate kept in contact with the coat. A cured adhesive layer as a second bonding layer was thus formed, and the LN substrate was bonded via the cured adhesive layer to the SiO₂ film (second low-refractive index layer).

Next, the MgO:LN substrate was ground and polished from an opposite side from the Si₂ film until the thickness of the MgO:LN substrate reached 3.7 μm.

### (2) Processing Step

Next, four groove portions were formed by laser processing in a surface (first surface) of the MgO:LN substrate that was on the opposite side from the SiO₂ film. Each of the four groove portions had a depth of 2.0 μm. The four groove portions each extended linearly in a first planar direction orthogonal to the thickness direction of the MgO:LN substrate. The four groove portions were arranged in parallel to one another in the second planar direction orthogonal to the first planar direction so as to be spaced apart from one another. Portions of the MgO:LN substrate that were located between two groove portions adjacent to each other out of the four groove portions were configured as ridge waveguides. In short, three ridge waveguides were formed in the MgO:LN substrate. Each of the three ridge waveguides included the periodically poled portion.

### (3) First Low-Refractive Index Layer Forming Step

Next, SiO₂ was deposited by sputtering on the surface (first surface) of the MgO:LN substrate that was on the opposite side from the SiO₂ film so as to cover the ridge waveguides. A SiO₂ film (4.0 μm-thick) as a first low-refractive index layer was thus formed.

### (4) First Polishing Step

Next, the SiO₂ film (first low-refractive index layer) was polished by CMP (a polishing method) from an opposite side from the MgO:LN substrate until a measurement between a surface of the SiO₂ film that was on the opposite side from the MgO:LN substrate and the ridge waveguides reached 0.5 μm. This rendered the surface of the SiO₂ film that was on the opposite side from the MgO:LN substrate a flat surface that was flat in the direction orthogonal to the thickness direction of the MgO:LN substrate.

### (5) First Bonding Step

Next, a cardo resin (curable adhesive) was evenly applied by spin coating to the flat surface of the SiO₂ film to form a coat having a thickness of 1.5 μm. Then the cardo resin (curable adhesive) was cured with a lithium niobate (LN) substrate (500 μm-thick) as a first support substrate kept in contact with the coat. A cured adhesive layer as a first bonding layer was thus formed, and the LN substrate was bonded via the cured adhesive layer to the SiO₂ film (first low-refractive index layer).

A wavelength conversion device was manufactured in the manner described above. The wavelength conversion device had a multi-layer structure including the LN substrate (first support substrate)/the cured adhesive layer (first bonding layer)/the SiO₂ film (first low-refractive index layer)/the MgO:LN substrate (non-linear optical material substrate)/the SiO₂ film (second low-refractive index layer)/the cured adhesive layer (second bonding layer)/the LN substrate (second support substrate).

### Comparative Example 1

A wavelength conversion device was manufactured in the same manner as in Example 1, except that the thickness of the SiO₂ film as the first low-refractive index layer formed in (3) first low-refractive index layer forming step described above was changed to 0.5 μm, and that (4) first polishing step described above was not executed.

### Evaluation

The wavelength conversion devices manufactured in Example and Comparative Example were observed with use of an optical microscope to check mixing-in of air bubbles. In the wavelength conversion device of Comparative Example 1, presence of air bubbles was confirmed between the SiO₂ film (first low-refractive index layer) and the cured adhesive layer (first bonding layer). In the multi-layer structure of the wavelength conversion device of Example 1, on the other hand, no mixing-in of air bubbles was confirmed. It is accordingly understood that the wavelength conversion device of Example 1 is superior to the wavelength conversion device of Comparative Example 1 in appearance and strength.

The waveguide device according to the embodiment of the present invention is usable in a wide range of fields such as next-generation optical communications and quantum-related fields, and is particularly favorably usable as a wavelength conversion device, an optical amplifier, and an optical modulator.

According to the embodiment of the present invention, it is possible to manufacture a waveguide device having excellent appearance and strength.

What is claimed is:

1. A method of manufacturing a waveguide device, comprising:
preparing a non-linear optical material substrate;
forming, in a first surface of the non-linear optical material substrate which is located on one side of a thickness direction, a plurality of groove portions extending in a direction intersecting with the thickness direction so that one groove portion is spaced apart from another groove portion, and configuring, as a ridge waveguide, at least one of portions of the non-linear optical material substrate that are located between groove portions adjacent to each other out of the plurality of groove portions;
forming, on the first surface of the non-linear optical material substrate, a first low-refractive index layer which is lower in refractive index than the non-linear optical material substrate and which has a thickness greater than a depth of the plurality of groove portions, so that the ridge waveguide is covered;
polishing the first low-refractive index layer from an opposite side from the non-linear optical material substrate to render a surface of the first low-refractive index layer that is on the opposite side from the non-linear optical material substrate a substantially flat surface; and
bonding, to the substantially flat surface of the first low-refractive index layer, a first support substrate via a first bonding layer.

2. The method of manufacturing a waveguide device according to claim 1, wherein the preparing of the non-linear optical material substrate includes:
forming, on a second surface of the non-linear optical material substrate which is on an opposite side from the first surface, a second low-refractive index layer which is lower in refractive index than the non-linear optical material substrate;
bonding, to a surface of the second low-refractive index layer that is on an opposite side from the non-linear optical material substrate, a second support substrate via a second bonding layer; and
polishing the non-linear optical material substrate from an opposite side from the second low-refractive index layer.

3. The method of manufacturing a waveguide device according to claim 2, wherein the preparing of the non-linear optical material substrate further includes, prior to the forming of the second low-refractive index layer, forming a periodically poled portion on the second surface of the non-linear optical material substrate.

4. The method of manufacturing a waveguide device according to claim 1, wherein the first bonding layer is formed of a resin material.

5. The method of manufacturing a waveguide device according to claim 2, wherein the second bonding layer is formed of a resin material.

6. The method of manufacturing a waveguide device according to claim 1, wherein the polishing of the first low-refractive index layer includes polishing the first low-refractive index layer until a measurement between the substantially flat surface of the first low-refractive index layer and the ridge waveguide in the thickness direction reaches 1.0 or less relative to the depth of the plurality of groove portions.

7. The method of manufacturing a waveguide device according to claim 6, wherein the depth of the plurality of groove portions is 1.5 μm or more and 3.0 μm or less.

8. The method of manufacturing a waveguide device according to claim 1, wherein the non-linear optical material substrate is formed of lithium niobate, and/or lithium tantalate, that contains magnesium oxide as a dopant.

9. The method of manufacturing a waveguide device according to claim 1, wherein the first low-refractive index layer contains silicon dioxide.

10. A method of manufacturing a waveguide device, comprising:
preparing a non-linear optical material substrate;
forming, in a first surface of the non-linear optical material substrate which is located on one side of a thickness direction, a plurality of groove portions extending in a direction intersecting with the thickness direction so that one groove portion is spaced apart from another groove portion, and configuring, as a ridge waveguide, at least one of portions of the non-linear optical material substrate that are located between groove portions adjacent to each other out of the plurality of groove portions;
forming, on the first surface of the non-linear optical material substrate, a first low-refractive index layer which is lower in refractive index than the non-linear optical material substrate and which has a thickness greater than a depth of the plurality of groove portions, so that the ridge waveguide is covered;
polishing the first low-refractive index layer from an opposite side from the non-linear optical material substrate to render a surface of the first low-refractive index layer that is on the opposite side from the non-linear optical material substrate a substantially flat surface; and
bonding, to the substantially flat surface of the first low-refractive index layer, a first support substrate via a first bonding layer,
wherein the preparing of the non-linear optical material substrate includes:
forming, on a second surface of the non-linear optical material substrate which is on an opposite side from the first surface, a second low-refractive index layer which is lower in refractive index than the non-linear optical material substrate;
bonding, to a surface of the second low-refractive index layer that is on an opposite side from the non-linear optical material substrate, a second support substrate via a second bonding layer;
polishing the non-linear optical material substrate from an opposite side from the second low-refractive index layer; and
forming a periodically poled portion on the second surface of the non-linear optical material substrate prior to the forming of the second low-refractive index layer,
wherein the first bonding layer is formed of a resin material,
wherein the second bonding layer is formed of a resin material,
wherein the polishing of the first low-refractive index layer includes polishing the first low-refractive index layer until a measurement between the substantially flat surface of the first low-refractive index layer and the ridge waveguide in the thickness direction reaches 1.0 or less relative to the depth of the plurality of groove portions,
wherein the depth of the plurality of groove portions is 1.5 μm or more and 3.0 μm or less,
wherein the non-linear optical material substrate is formed of lithium niobate, and/or lithium tantalate, that contains magnesium oxide as a dopant, and
wherein the first low-refractive index layer contains silicon dioxide.
